(19) United States
(12) Patent Application Publication
(10) Pub. No.: US 2024/0138620 A1
(43) Pub. Date: May 2, 2024

(54) IMPROVEMENTS IN COOKING DEVICES

(71) Applicant: Marc CARDINALI, Waterdown (CA)

(72) Inventor: Marc CARDINALI, Waterdown (CA)

(21) Appl. No.: 18/482,125

(22) Filed: Oct. 6, 2023

Related U.S. Application Data
(60) Provisional application No. 63/414,422, filed on Oct. 7, 2022.
(60) Provisional application No. 63/423,585, filed on Nov. 8, 2022.

(51) Int. Cl. A47J 37/07

(52) U.S. Cl. CPC A47J 37/0786; A47J 37/0704

(57) ABSTRACT

Improvements in outdoor cook trailers include: C-shaped channels defining the longitudinal members carried by trailer wheels; a trailer having a removable axle, adapted to receive casters at its rear and that can pass through a human entry door; a firebox having an inner sleeve of heavy steel welded to an oven wall, an outer sleeve of heavy steel secured in surrounding relation to the inner sleeve and projecting slightly therebeyond, an insulation layer disposed between the inner sleeve and the outer sleeve, an outer wall welded to the outer sleeve and having an aperture for stoking the firebox and a door hingedly secured to the outer wall to occlude the aperture; a cylindrical vent rotatably mounted to the cooker lid, the vent having an arcuate slot defined therewithin that is selectively occludable by a rotatably mounted arcuate damper.

### CROSS-REFERENCE TO RELATED APPLICATIONS

This application claims the benefit of U.S. Provisional Patent Application Ser. No. 63/414,422, filed Oct. 7, 2022.

### FIELD

The invention relates to outdoor grilling, smoking and barbeque.

### BACKGROUND

The cooking device shown and described in PCT/CA2020/050883 is known to have utility but, like all devices, is susceptible to improvement.

### SUMMARY OF THE INVENTION

Forming one aspect of the invention is an improved road trailer, of the type having a pair of longitudinal members forming part of a frame and a pair of rear wheels carrying the frame, the improvement comprising: a pair of C-shaped channels defining the pair of longitudinal members.

According to another aspect of the invention, the rear wheels can be mounted on an axle, the axle can be coupled to the frame for easy removal, the frame can be adapted to receive a pair of casters at its rear and the frame can be narrow enough to pass through a conventional human entry door.

Forming another aspect of the invention is an improved barbeque of the type having a firebox welded to the bulkhead wall of the oven and a firebox vent opening in the wall to permit air movement between the oven and the firebox. This improvement comprises: an inner sleeve of heavy steel welded to the wall in surrounding relation to the aperture; an outer sleeve of heavy steel secured to the wall in surrounding relation to the inner sleeve and projecting slightly therebeyond; an insulation layer disposed between the inner sleeve and the outer sleeve; an outer wall welded to the outer sleeve and having an aperture for stoking the firebox; and a door hingedly secured to the outer wall to occlude the aperture.

Forming yet another aspect of the invention is an improved barbeque of the type having a cooking chamber with an aperture and a lid pivotably mounted to the cooking chamber to selectively occlude the aperture, the improvement comprising: a cylindrical vent rotatably mounted to the lid, the vent having an arcuate slot defined therewithin; and an arcuate damper is rotatably mounted for movement between a position wherein the slot is substantially unobstructed and a position wherein the slot is substantially occluded.

Other advantages, features and characteristics of the invention will become apparent upon review of the detailed description which follows, with reference to the appended drawings, the latter being briefly described hereinbelow.

### BRIEF DESCRIPTION OF THE DRAWINGS

In the figures:

FIG. 1 shows a cooking device according to an example of the invention in a cooking position.

FIG. 2A is a perspective view of the structure of FIG. 1 with the cooking device removed for clarity.

FIG. 2B is a side view of the structure of FIG. 2A;

FIG. 2C is a front view of the structure of FIG. 2A;

FIG. 2D is an enlarged view of encircled area 2D of FIG. 2C;

FIG. 3A is a view similar to FIG. 2A, but of alternative embodiment.

FIG. 3B is a side view of the structure of FIG. 3A;

FIG. 3C is a front view of the structure of FIG. 3A;

FIG. 3D is an enlarged view of encircled area 3D of FIG. 3C;

FIG. 4 a portion of the structure of FIG. 1;

FIG. 5 is a view of another portion of FIG. 1;

FIG. 6 is a view of another portion of FIG. 1;

FIG. 7 is an exploded view of a portion of FIG. 2A;

FIG. 8A is a cross section of a portion of the structure of FIG. 1;

FIG. 8B is an end view of a portion of the structure of FIG. 1;

FIG. 9 is an interior view of the structure of FIG. 1;

FIG. 10 is a partial end view of the structure of FIG. 1;

FIG. 11 is another partial view of the structure of FIG. 1;

FIG. 12 is another partial view of the structure of FIG. 1 with the lid open position;

FIG. 13 is a view similar to FIG. 12;

FIG. 14 is an enlarged view of a portion of the structure of FIG. 13;

FIG. 15 is an enlarged view of a portion of the structure of FIG. 1;

FIG. 16 shows a further embodiment of the invention;

FIG. 17 is an enlarged view of encircled area 17 of FIG. 16;

FIG. 18 is an exploded view of the structure of FIG. 16;

FIG. 19 is a view of the structure of FIG. 18 in use with casters;

FIG. 20 is an end view of the structure of FIG. 19;

FIG. 21 is an enlarged view of the structure of encircled area 21 of FIG. 16;

FIG. 22 is a cross-sectional view of the structure of encircled area 22 of FIG. 21;

FIG. 23 is a view of the grill and grill basket of the structure of FIG. 16;

FIG. 24 is an exploded view of the structure of FIG. 23;

FIG. 25 is a view of the structure of FIG. 23 in use with legs;

FIG. 26 is an enlarged view of encircled area 26 of FIG. 16; and

FIG. 27 is a cross-section of the structure of FIG. 26.

### DETAILED DESCRIPTION

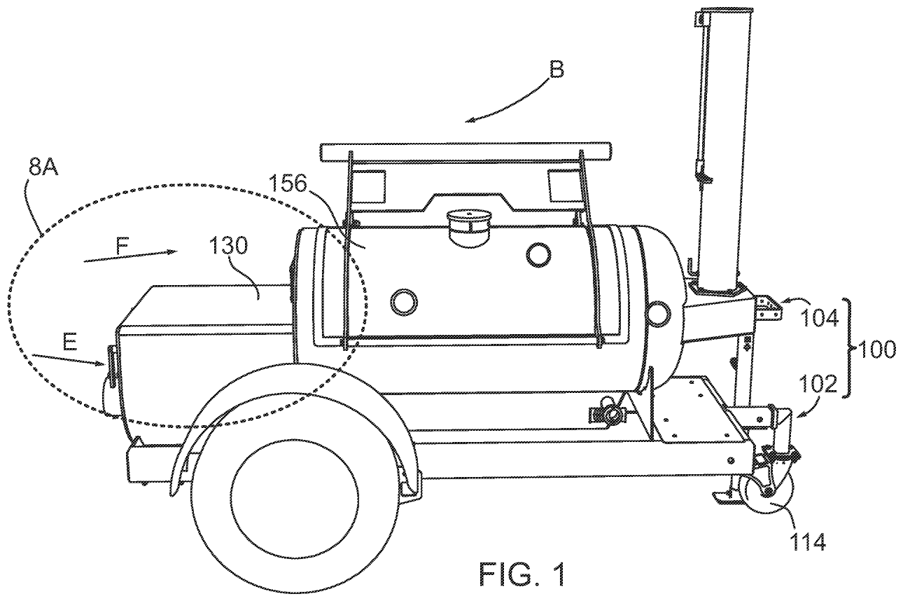

A cooking device according to an embodiment of that shown and described in PCT/CA2020/050883, incorporated herein by reference, is shown in FIGS. 1-15.

FIG. 1 shows the cooking device in a cooking position.

The device shown and described herein inventively differs from that shown in PCT/CA2020/050883 in the following ways.
reconfigurable trailer
trailer construction
firebox construction
lid construction

### Reconfigurable Trailer

The trailer has, as is conventional, an axle in receipt of a pair of wheels and supporting a frame, a pair of fenders secured to the frame and covering the wheels and a hitch mount forming part of the frame which can receive a caster. The wheels and the caster permit the trailer to be rolled around, for example, in a parking lot, when disconnected from a tow vehicle, as shown in FIG. 1, and the fenders allow the trailer to be towed behind a tow vehicle on public roads.

However, the trailer is notable in that:
the frame is adapted to receive a pair of casters at its rear
the fenders and axle are coupled to the frame by bolts for easy removal
the frame is narrow enough to pass through a conventional human entry door

The trailer thus can be towed on public roads [on its wheels] but can also traverse paths normally reserved to humans and carts.

This has specific advantage in the field of cooking, since it enables relatively large, professional quality outdoor cooking devices to be moved relatively easily between spaces normally not connected by roads.

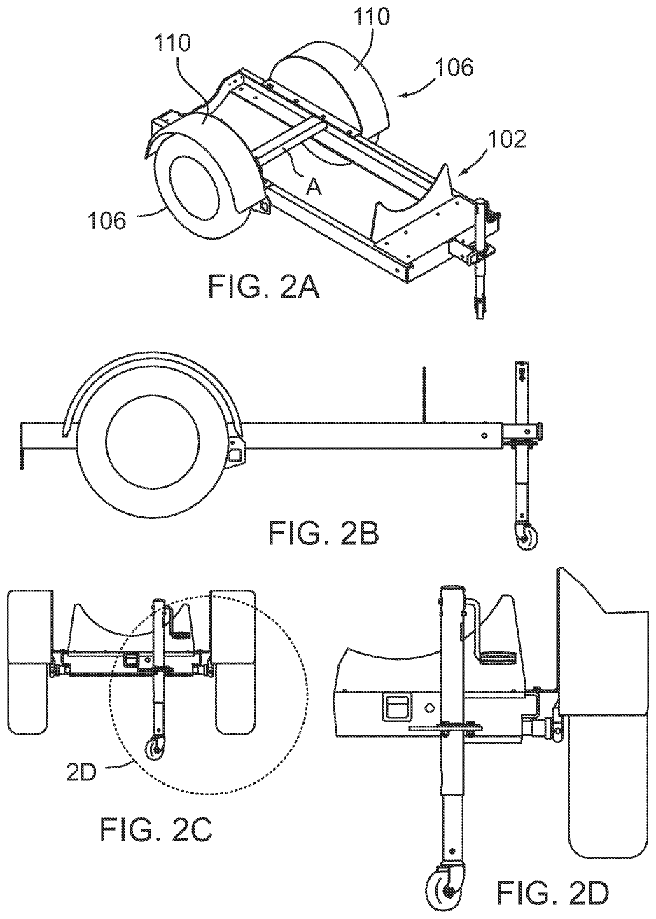

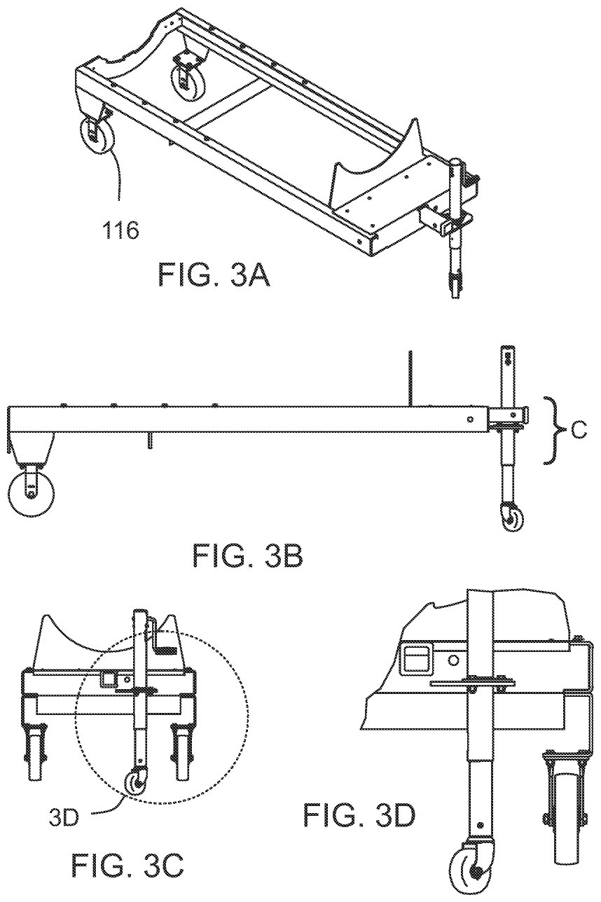

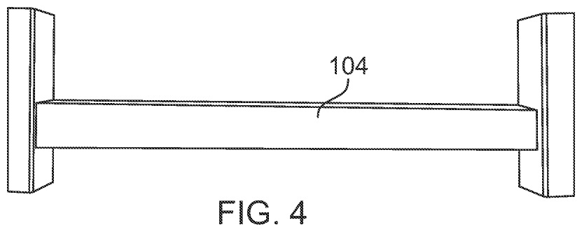

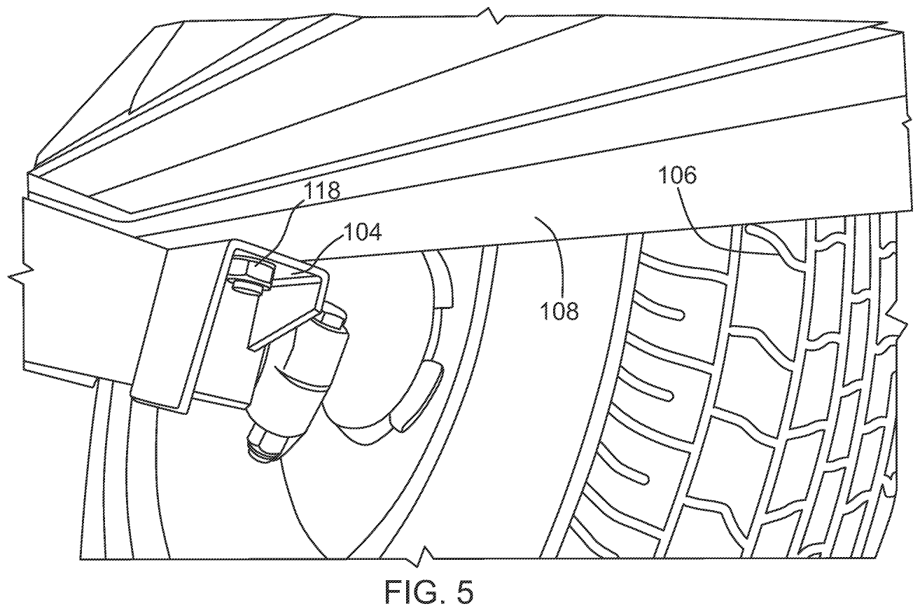

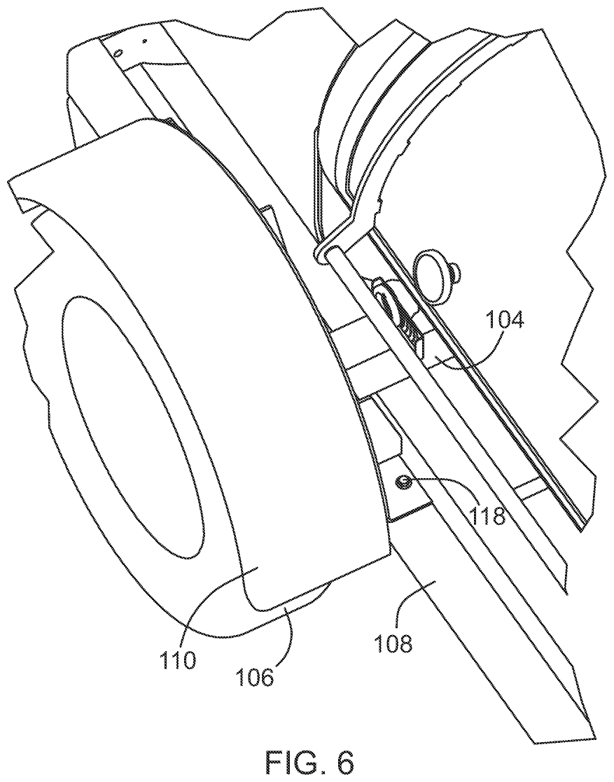

Further details of the device are described below with reference to the drawings. FIG. 2 is a view of the structure of FIG. 1 with the cooking device removed for clarity. FIG. 3 is a view similar to FIG. 2, but showing the axle, wheels and fenders removed and the casters installed. FIG. 4 shows the axle in isolation. FIG. 5 is a view showing the axle bolted to the frame. FIG. 6 is a view showing the fender bolted to the frame.

### Trailer Construction

The trailer is conventional in that includes a pair of longitudinal members securely connected to one another in spaced relation.

However, the trailer is notable in that the longitudinal members are channels.

As shown, the channels are secured to one another by a plurality of member including:
a rearmost brace, occluding the ends of the channels and welded thereto;
an intermediate brace, extending between the channels at a location intermediate the front and end of the trailer and welding to the channels
an axle-supporting angle welded to and beneath the channels
an angle plate occluding the front ends of the channels and welded to and above the channels

The use of channels has significant advantage in terms of, inter alio, corrosion resistance.

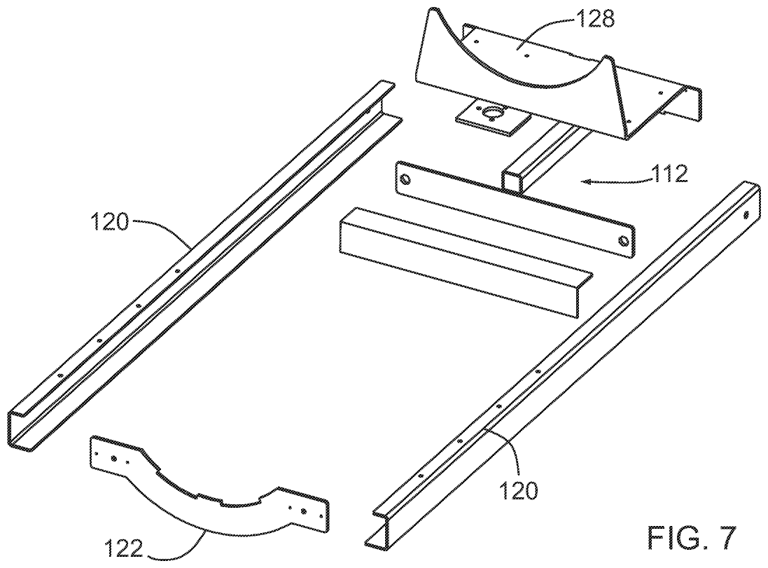

For greater clarity, FIG. 7 is an exploded view of the frame, prior to welding.

### Firebox Construction

The barbeque has a firebox for offset cooking. The firebox is indicated in FIG. 1

As is conventional, the firebox is welded to the bulkhead wall of the oven and the wall has a firebox vent opening to permit air movement between the oven and the firebox.

However, this firebox has
an inner sleeve of heavy steel welded to the wall in surrounding relation to the aperture
an outer sleeve of heavy steel secured to the wall in surrounding relation to the inner sleeve and projecting slightly therebeyond
an insulation layer disposed between the inner sleeve and the outer sleeve
an outer wall welded to the outer sleeve and having an aperture for stoking the firebox;
a door hingedly secured to the outer wall to occlude the aperture
threaded studs welded to the bulkhead wall projecting into the cooking compartment
a plate adapted to be suspended by the threaded studs to occlude the vent.

The thermal separation between the inner sleeve and the outer wall has advantage in that thermal expansion is less likely to impair operation of the door.

The plate can be secured in place by wing nuts, to isolate the firebox when not in use, and removed, when communication between the firebox and the cooking compartment is required.

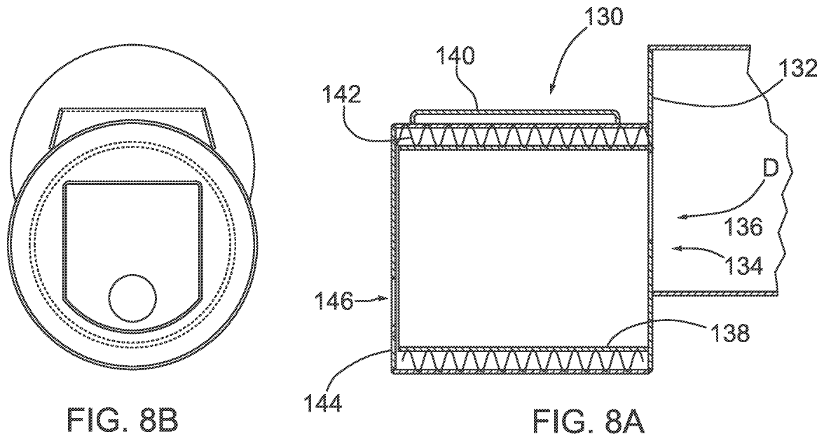

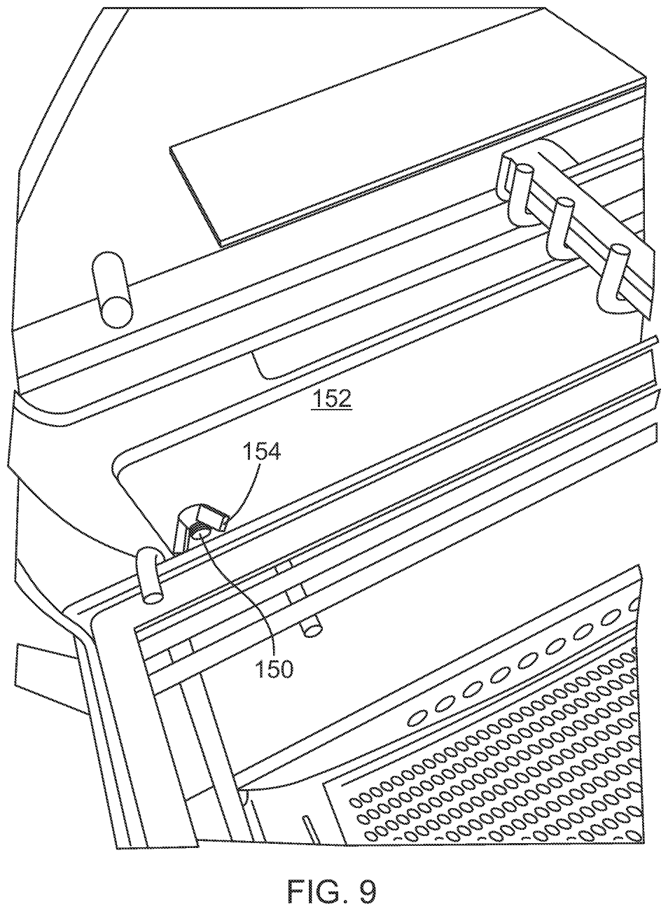

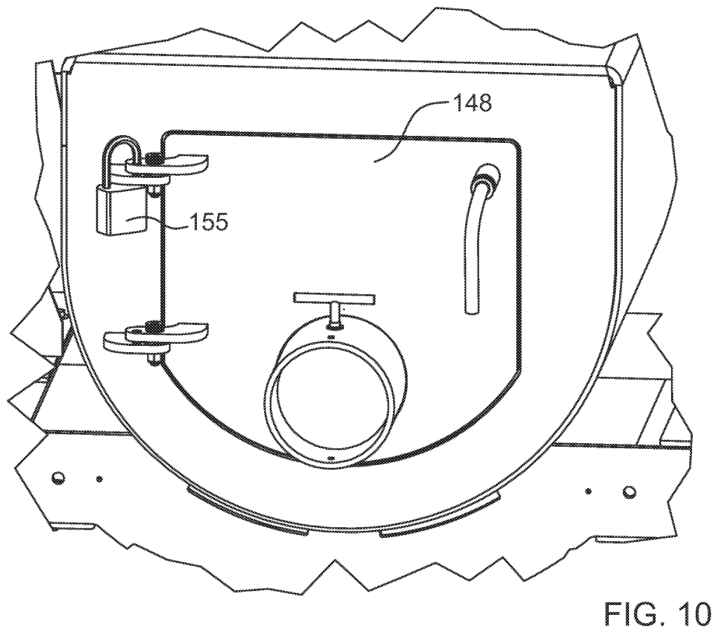

Further details are described with reference to the drawings. FIG. 8 is a cross section showing the inner sleeve, outer sleeve, insulation layer, aperture, vent and bulkhead wall. FIG. 9 shows the plate secured in place; one of the threaded studs and one of the wing nuts is visible. FIG. 10 shows the door occluding the aperture and secured shut with a lock.

### Lid Construction

The cooking device, as is conventional, has a hinged arcuate lid which selectively occludes the opening to the cooking chamber. The lid is shown in FIG. 1

However, this lid has:
a pair of plates welded to the oven, each plate having four bores;
a pair of heavy gauge arcuate braces welded to the lid and having three bores;
a counterweight rigidly securing the braces together

The counterweight assists in opening and closing the heavy lid which would otherwise be quite difficult to move.

One set of the bores is used for a pair of hinge pins that provide for conventional hinged movement of the lid between open and closed positions.

One set of the bores is aligned when the lid is in the closed position and can be used to lock the lid closed, to prevent food theft.

One set of the bores is aligned when the lid is open and can be used to lock the lid open, to prevent inadvertent closure of the lid.

A final set of the bores receives bumper pins, to arrest movement of the lid beyond the open position and subsequent paint damage.

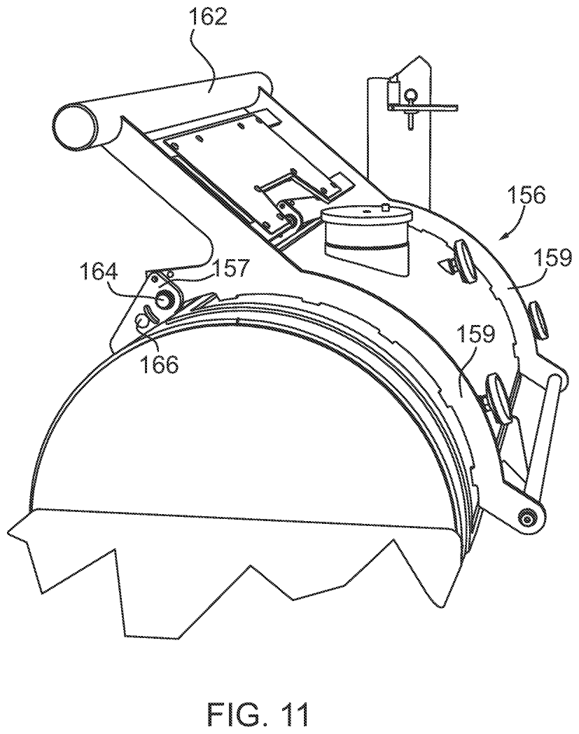

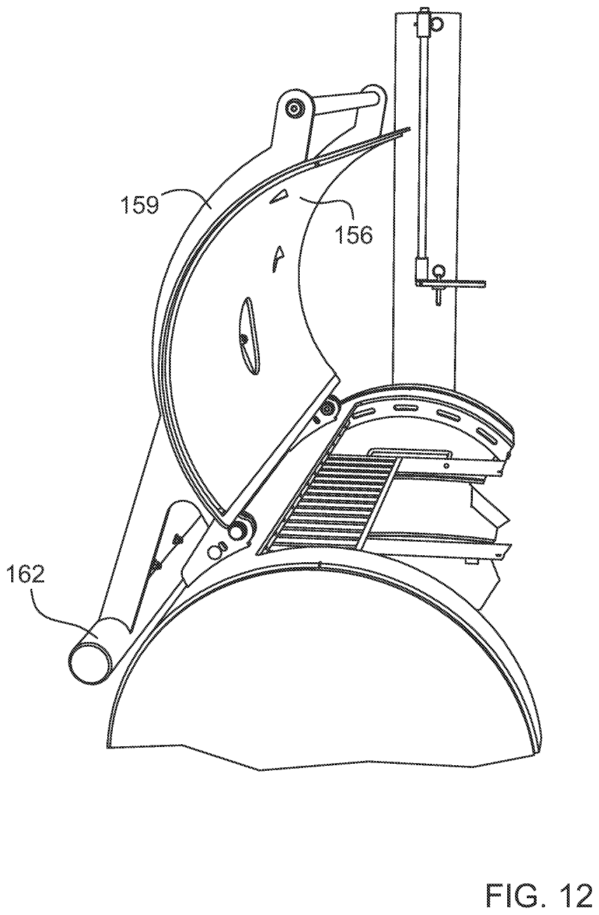

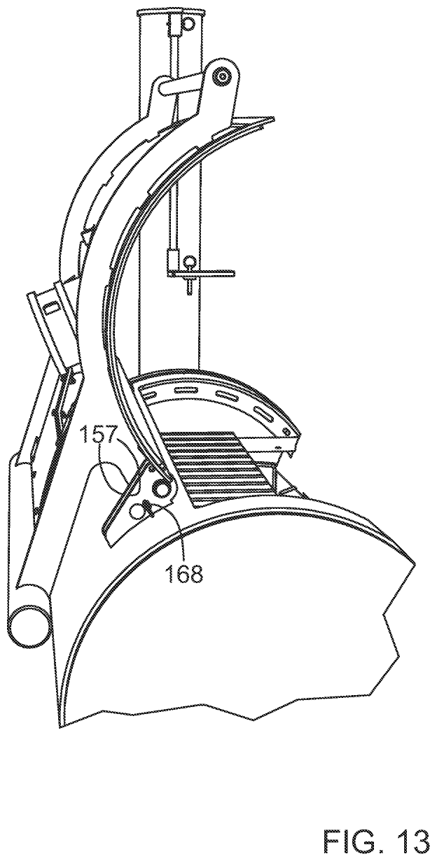

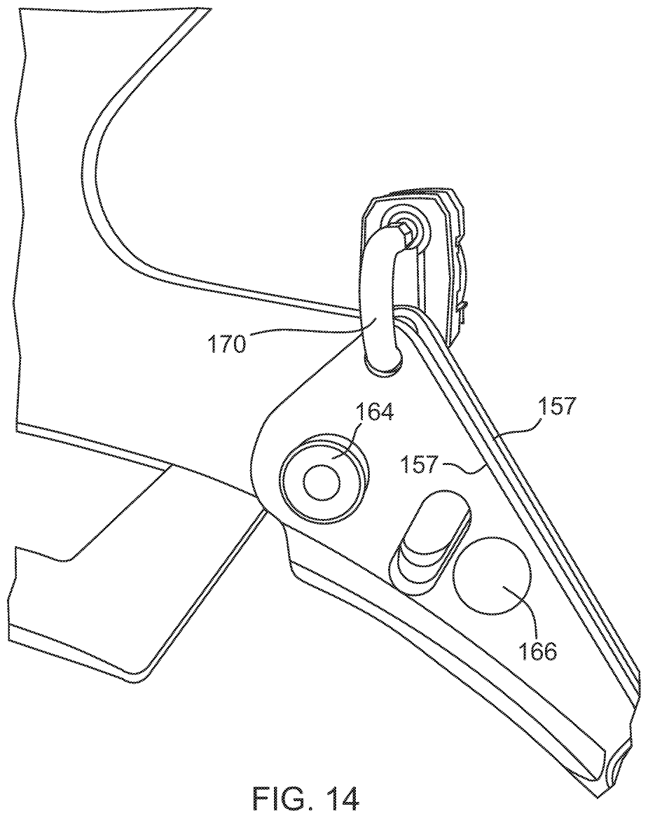

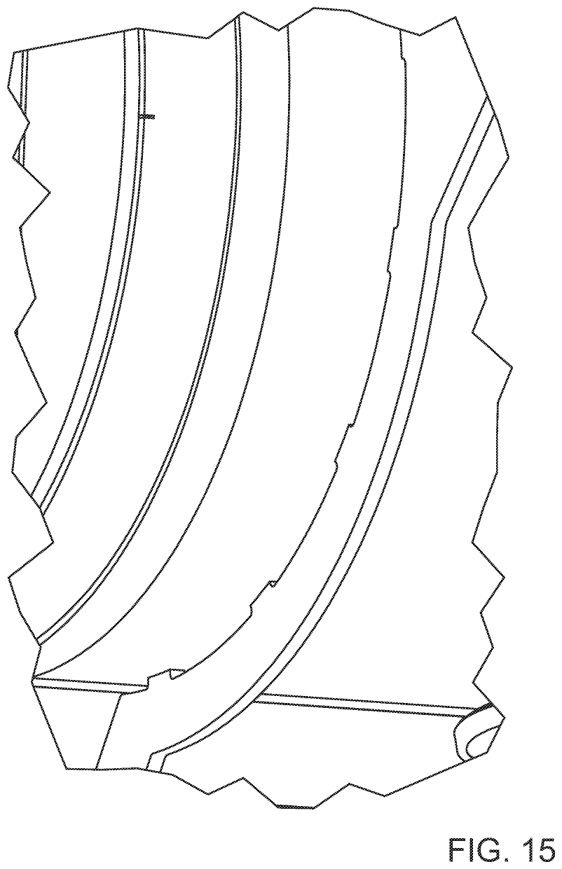

Further details are described with reference to the drawings. FIG. 11 shows the braces, the counterweight, one of the plates, a hinge pin and a bumper pin, the lid being shown in the closed position. FIG. 12 shows the lid in the open position and the aligned bores that can be used to lock the lid open. FIG. 13 shows a cotter pin received by the aligned bores of FIG. 12 to hold the lid open. FIG. 14 shows the lid in the closed position and a padlock engaged through the bores that are aligned when the lid is in the closed position. FIG. 15 is a view showing the welded connections of the braces.

### FURTHER EMBODIMENT

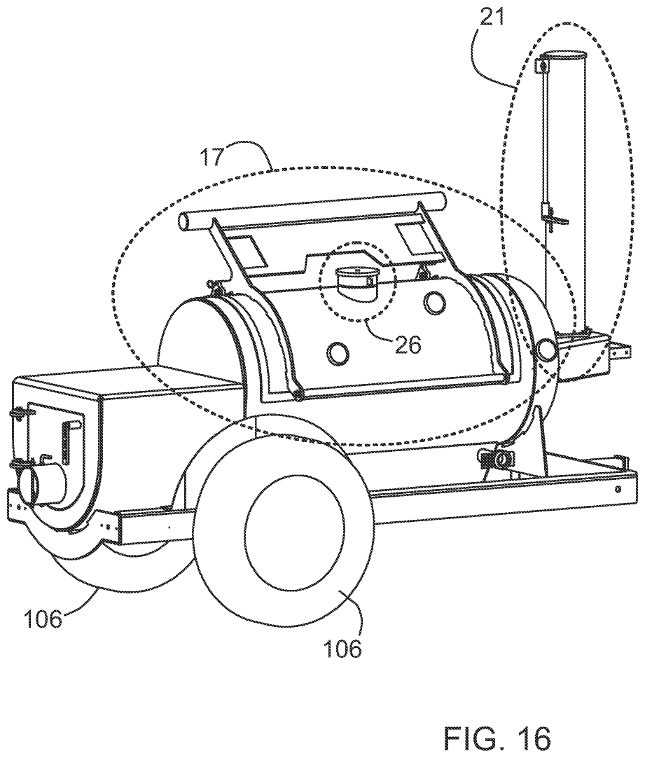

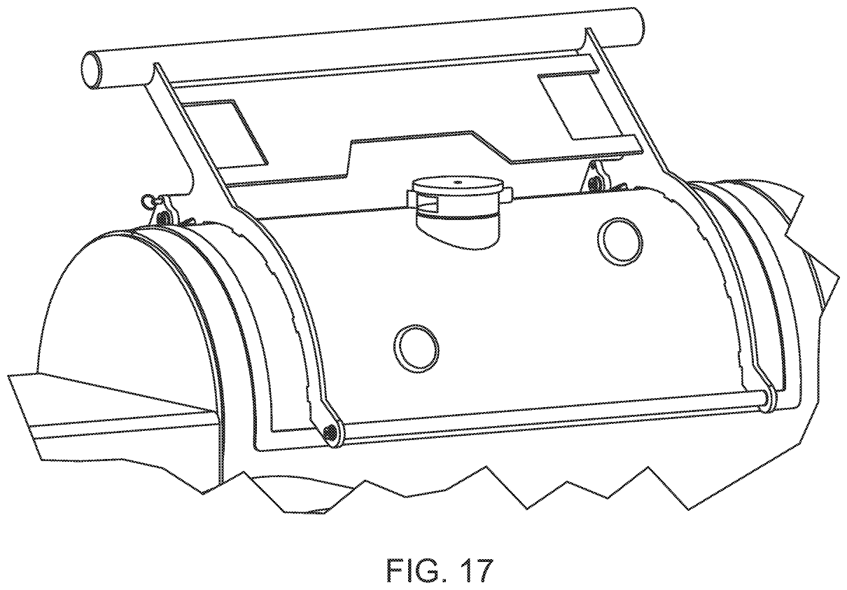

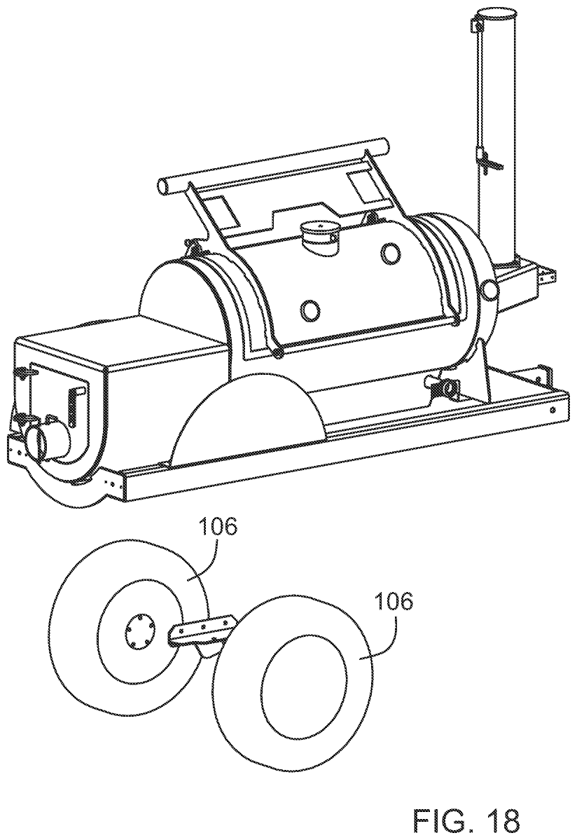

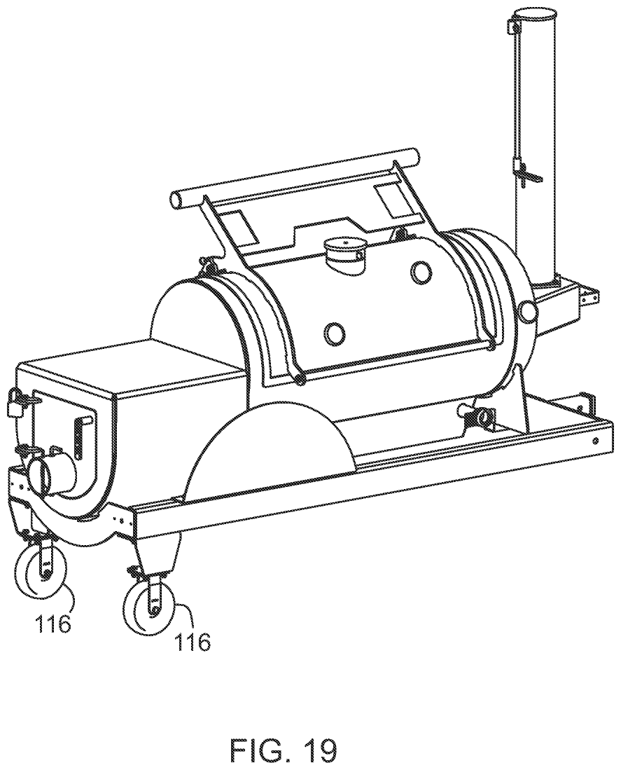

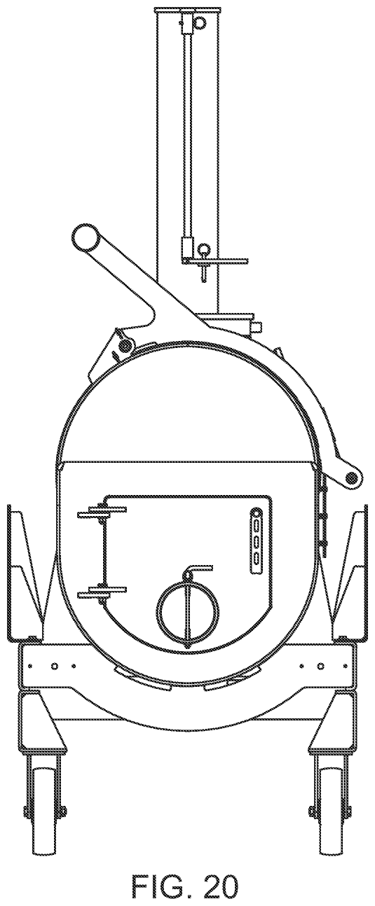

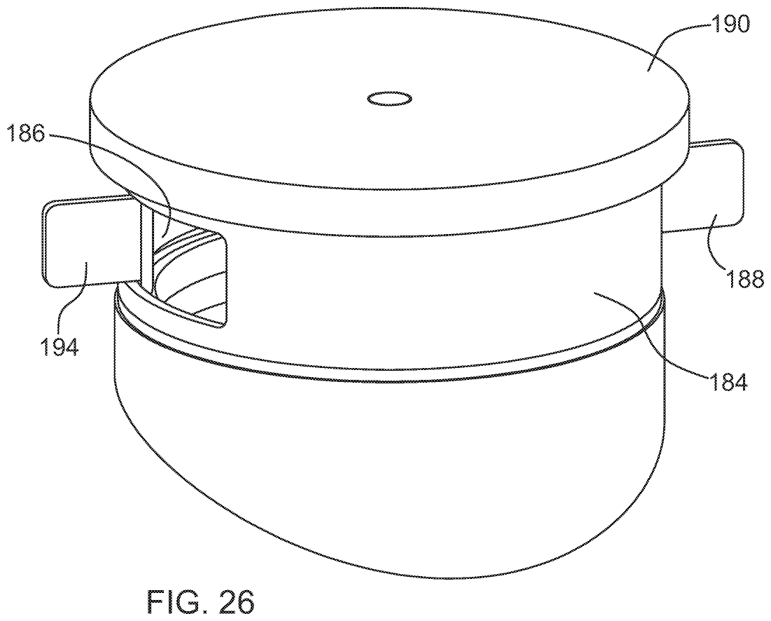

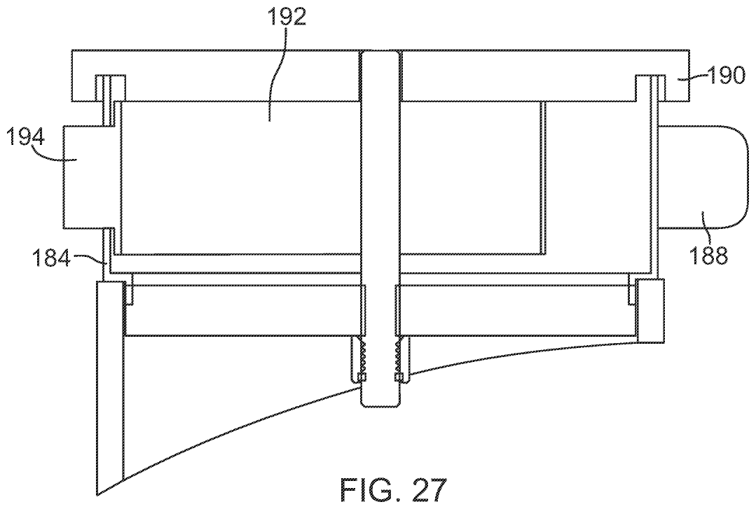

An alternate embodiment is shown in FIGS. 16-27.

The alternate embodiment of FIGS. 16-27 incorporate several improvements in construction over the embodiment shown in FIGS. 1-15

### Main Stack Shutoff

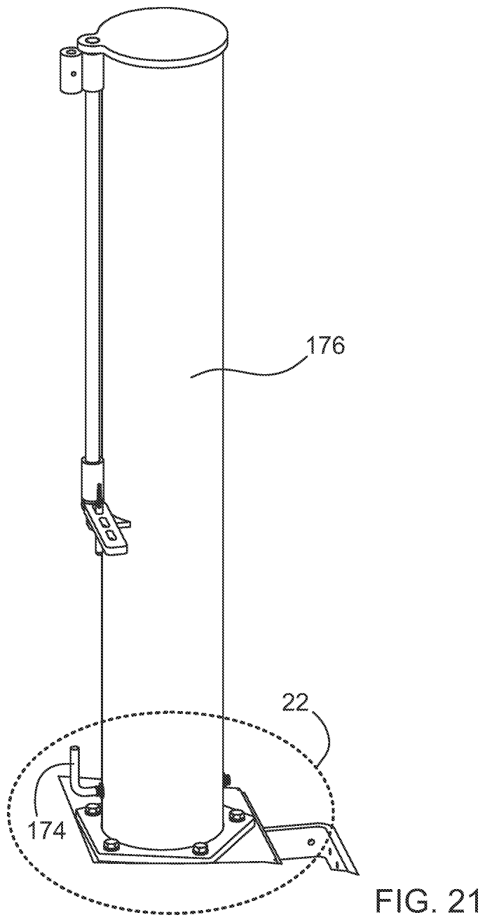

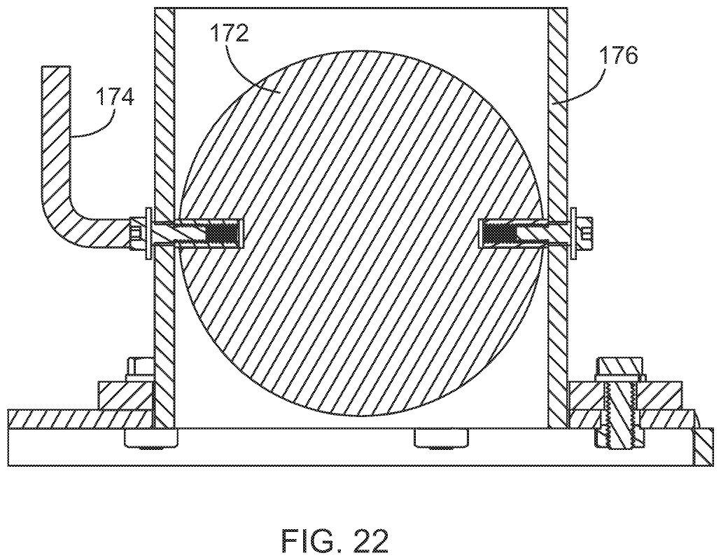

A main stack shutoff is shown in FIGS. 21-22 and will be seen to include a butterfly valve actuable by a handle. Positioning the handle to point vertically orients the butterfly valve vertically, to permit air to flow freely through the stack, as shown in FIG. 22. Positioning the handle to point horizontally substantially occludes the stack.

### Two-Part Removable Grill Basket

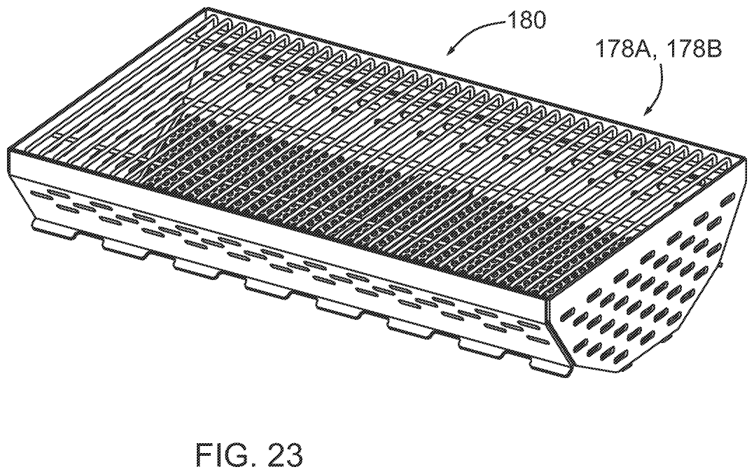

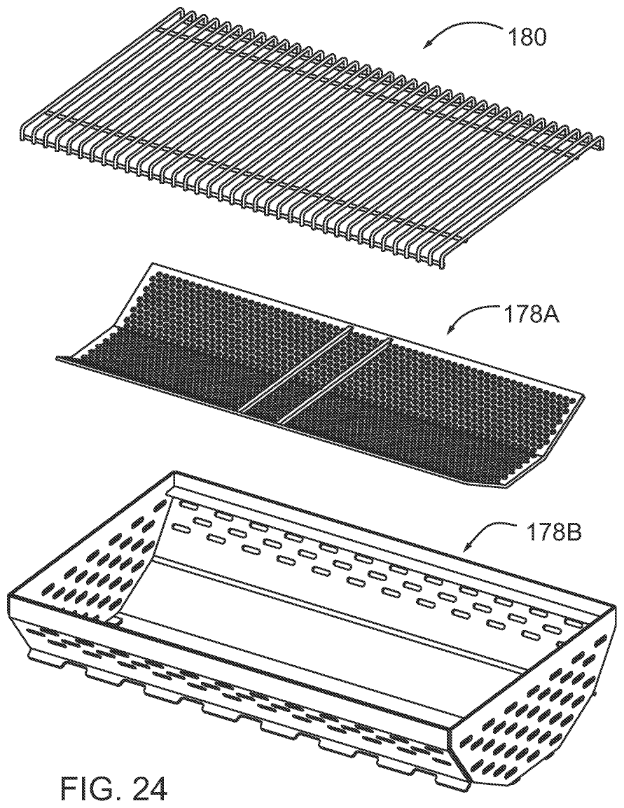

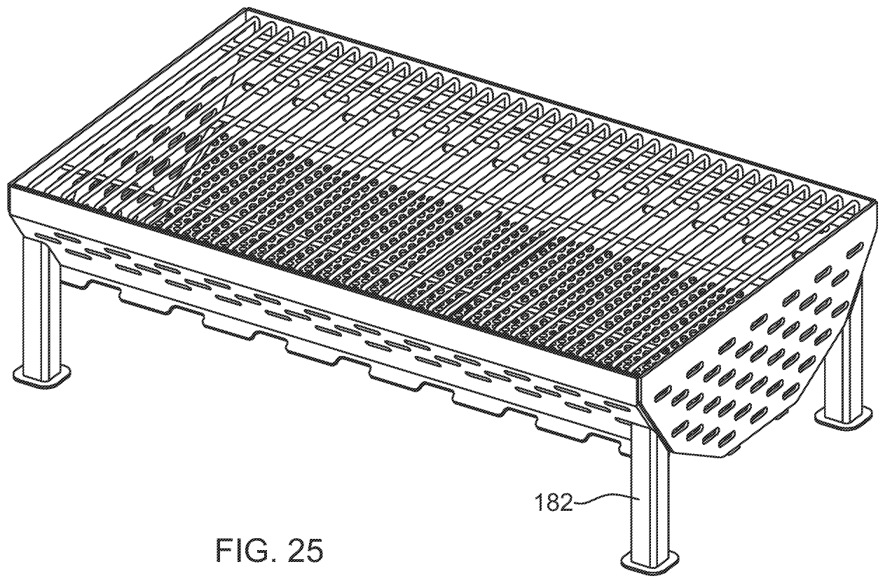

A two-part removable grill basket is described with reference to the FIGURES. FIG. 23 demonstrates that the grill basket can be removed from the cook chamber. FIG. 24 demonstrates that the grill can be removed from the grill basket, as is conventional, and further demonstrates that the grill basket can be separated in two parts, 1 and 2. Part 1 can be removed—when Part 2 remains in the cook chamber—to permit easy cleaning of the base of the cook chamber. FIG. 25 demonstrates that the grill basket can be provided with legs to render it useful as a hibachi style grill

### Directional Vent

Rotatably mounted to the lid of the cooking chamber is a cylindrical vent having an arcuate slot defined therewithin. A handle is rigidly mounted to the vent in opposing relation to the slot. The vent is occluded by a cap and an arcuate damper is rotatably mounted for movement between a position wherein the slot is substantially unobstructed and a position wherein the slot is substantially occluded. A tab is connected to the damper to facilitate such movement. The damper is shown at an intermediate position. In high wind conditions, the main stack can be occluded and the arcuate slot can be orientated to point downwind, thereby to allow for good venting without significant interference by the wind with the fire.

### VARIATIONS

Whereas specific embodiments are described herein, variations are possible. Accordingly, the invention should be understood to be limited only by the accompanying claims, purposively construed.

1. An improved road trailer, of the type having a pair of longitudinal members forming part of a frame and a pair of rear wheels carrying the frame, the improvement comprising:
a pair of C-shaped channels defining the pair of longitudinal members.

2. The trailer of claim 1, wherein the rear wheels are mounted on an axle, the axle is coupled to the frame for easy removal, the frame is adapted to receive a pair of casters at its rear and the frame is narrow enough to pass through a conventional human entry door.

3. An improved barbeque of the type having a firebox welded to the bulkhead wall of the oven and a firebox vent opening in the wall to permit air movement between the oven and the firebox, the improvement comprising: an inner sleeve of heavy steel welded to the wall in surrounding relation to the aperture; an outer sleeve of heavy steel secured to the wall in surrounding relation to the inner sleeve and projecting slightly therebeyond; an insulation layer disposed between the inner sleeve and the outer sleeve; an outer wall welded to the outer sleeve and having an aperture for stoking the firebox; and a door hingedly secured to the outer wall to occlude the aperture.

4. An improved barbeque of the type having a cooking chamber with an aperture and a lid pivotably mounted to the cooking chamber to selectively occlude the aperture, the improvement comprising:
a cylindrical vent rotatably mounted to the lid, the vent having an arcuate slot defined therewithin; and
an arcuate damper is rotatably mounted for movement between a position wherein the slot is substantially unobstructed and a position wherein the slot is substantially occluded.
